(19) United States
(12) Patent Application Publication
(10) Pub. No.: US 2010/0196654 A1
(43) Pub. Date: Aug. 5, 2010

(54) PROCESS FOR PRODUCING COMPOSITE LAMINATE STRUCTURES AND COMPOSITE LAMINATE STRUCTURES FORMED THEREBY

(75) Inventor: Mahendra Maheshwari, Bel Air, MD (US)

Correspondence Address: HARTMAN AND HARTMAN, P.C., 552 EAST 700 NORTH, VALPARAISO, IN, 46383, US

(73) Assignee: MRA SYSTEMS, INC., Baltimore, MD (US)

(21) Appl. No.: 12/362,515

(22) Filed: Jan. 30, 2009

(51) Int. Cl. B32B 3/06; B32B 38/08; B32B 37/00; B32B 27/12

(52) U.S. Cl. 428/102; 156/148; 156/245

(57) ABSTRACT

A process for producing resin-impregnated laminate composite structures that comprise a closed-cell core between resin-impregnated fabric layers, and preliminary and composite structures formed by such a process. The process includes stitching a roving in a preliminary structure that includes the core so as to structurally reinforce the core. The roving passes through through-holes in the core and traverses opposite outer surfaces of the preliminary structure. The outer surfaces of the preliminary structure traversed by the roving may be defined by outer surfaces of the core, or the preliminary structure may further include two or more fabric layers on outer surfaces of the core such that the core is between the fabric layers, the roving passes through one or more fabric layers, and at least one of the outer surfaces of the preliminary structure and traversed by the roving is defined by a fabric layer.

### BACKGROUND OF THE INVENTION

The present invention generally relates to composite articles and processes for their production. More particularly, this invention relates to composite structures comprising resin-impregnated fabric laminates and to a process for enhancing the load-carrying capability (including shear and through-thickness tension) of such structures.

A typical construction used in aircraft engine nacelle components (for example, the engine inlet, thrust reversers, core cowl, and transcowl) and other aerostructures (including acoustic panels) is a sandwich-type layered structure comprising a core material between relatively thinner top and bottom composite layers or skins. The core material is typically a lightweight material that has an open-cell or otherwise porous construction. Particular examples include open-cell ceramic, metal, carbon and thermoplastic foams and honeycomb-type materials formed of, for example, NOMEX® aramid fibers. A variety of materials are used for the composite skins, with common materials including a fabric material (for example, a graphite fabric) impregnated with resin (for example, an epoxy resin). A conventional process for producing these layered structures is to separately produce the composite skins by impregnating the fabric with the resin and then precuring the impregnated skins. The precured pre-impregnated skins are then bonded to the core material under pressure and heat, typically performed in an autoclave, during which additional curing occurs. Disadvantages associated with this process include long cycle times, high capital investment, and difficulty when attempting to implement for complex geometries.

Alternative processes for producing layered composite structures include the use of core materials having a closed-cell or otherwise nonporous construction, permitting the use of processes such as resin transfer molding (RTM) and vacuum-assisted resin transfer molding (VaRTM) that do not involve the use of an autoclave. Examples of closed-cell core materials include wood (for example, balsa wood) and other cellulosic materials, and closed-cell low-density structural foam materials, a particularly notable example of which is formed of polymethacrylimide and commercially available under the name ROHACELL® from Evonik Industries (formerly Degussa). While overcoming cost and investment disadvantages associated with autoclaving processes, the use of structural foams has certain disadvantages, particularly in terms of the shear and tension load-carrying capability of the resulting composite structure.

### BRIEF DESCRIPTION OF THE INVENTION

The present invention provides a process for producing resin-impregnated laminate composite structures that comprise a closed-cell core between resin-impregnated fabric layers, and composite structures formed by such a process. The invention can be employed to produce aircraft engine nacelle components, including engine inlets, thrust reversers, core cowls, and transcowls, as well as other aerostructures (such as wing leading and trailing fairings) and a variety of other sandwich-type layered structures.

According to a first aspect of the invention, the process includes stitching a roving in a preliminary structure comprising the core so as to structurally reinforce the core. The roving passes through through-holes in the core and traverses opposite outer surfaces of the preliminary structure, and the roving and a resin close the through-holes in the core. The angle at which the roving passes through the core can be tailored to obtain a desired shear and tension load-carrying capability for the core.

According to a second aspect of the invention, the outer surfaces of the preliminary structure traversed by the roving may be defined by outer surfaces of the core, in which case the process may further include applying at least two fabric layers to the outer surfaces of the core after the stitching step so that the core is between the at least two fabric layers. The roving does not pass through any of the at least two fabric layers, and the roving is covered by the at least two fabric layers.

According to a third aspect of the invention, the preliminary structure may further comprise at least two fabric layers on outer surfaces of the core such that the core is between the two fabric layers. The roving would then pass through at least one of the at least two fabric layers, and at least one of the outer surfaces of the preliminary structure traversed by the roving would be defined by the at least one fabric layer.

Still other aspects of the invention are the preliminary structures described above and the resin-impregnated laminate composite structures formed therewith.

Significant advantages of this invention include the potential for improved load-carrying capability (particularly in terms of shear and through-thickness tension), while permitting the use of lower-cost core materials and processes including, respectively, closed-cell core materials and RTM/VaRTM processes. As such, shorter cycle times and significantly reduced capital equipment investments are possible with the invention, including the ability to perform the curing process without an autoclave, and the use of lower curing temperatures that allow the use of lower-cost tooling. The process is also compatible with the production of composite structures with relatively complex geometries.

Other aspects and advantages of this invention will be better appreciated from the following detailed description.

### BRIEF DESCRIPTION OF THE DRAWINGS

FIG. 1 is a perspective view of a fan cowl of a type used for an aircraft engine nacelle.

FIGS. 2 and 3 schematically represent composite structures with, respectively, honeycomb and closed-cell cores of types known in the prior art.

FIG. 4 schematically represents a cross-sectional view of a closed-cell structural foam core with a roving reinforcement in accordance with a first embodiment of this invention.

FIG. 5 schematically represents a cross-sectional view of a composite structure comprising the roving-reinforced core of FIG. 4 between a pair of fabric stacks in accordance with the first embodiment of the invention.

FIGS. 6 and 7 schematically represent cross-sectional and plan views, respectively, of a composite structure comprising a closed-cell structural foam core between a pair of fabric stacks, with a roving reinforcement through the entire composite structure in accordance with another embodiment of this invention.

FIG. 8 schematically represents a cross-sectional view of a composite structure similar to FIG. 6, but with a roving reinforcement disposed at an oblique angle through the entire composite structure in accordance with still another embodiment of this invention.

FIGS. 9 and 10 are scanned images of a closed-cell structural foam before and after reinforcement with graphite roving in accordance with the embodiment of FIG. 4.

FIG. 11 schematically represents an exploded view of the composite structure of either FIG. 4 or 6, and a mold on which the composite structure is placed to mold one-half of the fan cowl of FIG. 1.

### DETAILED DESCRIPTION OF THE INVENTION

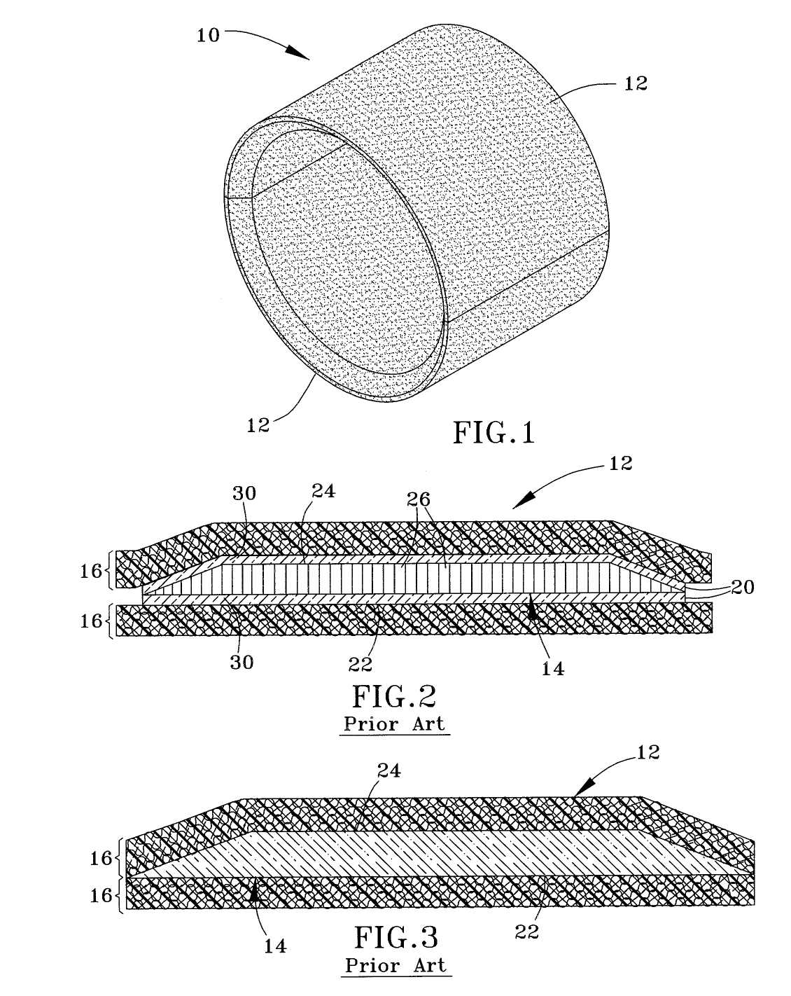

FIG. 1 is representative of an aircraft engine nacelle 10 that has two engine inlet (fan) cowls 12 that can be produced using processing steps of the present invention. While the invention will be described in reference to the fan cowls 12, it should be understood that the invention is applicable to a variety of components that benefit from having a composite structure, including but not limited to other aircraft engine nacelle components (for example, thrust reversers, core cowls, and transcowls) and other aerostructures (for example, acoustic panels).

Each fan cowl 12 has a resin-impregnated composite structure that includes a core layer between a pair of outer skins. FIGS. 2 and 3 represent two examples of conventional constructions for fan cowls. In each example, a core 14 is disposed between resin-impregnated stacks 16 of individual fabric layers. The core 14 of FIG. 2 is constructed of an open-cell honeycomb material with continuous passages 26 passing entirely through the core 14. A nonlimiting example of this type of core material is the aforementioned NOMEX® aramid fibers. Such core materials are well known in the art, and therefore will not be discussed in any detail. It should suffice to say that the passages 26 typically have a hexagonal cross-sectional shape with a typical cell width of about three to about ten millimeters, though lesser and greater widths are also foreseeable. In contrast, the core 14 of FIG. 3 is constructed of a closed-cell or otherwise nonporous material that lacks the continuous passages 26 of FIG. 2. A nonlimiting example of this type of core material is the aforementioned polymethacrylimide foam material commercially available under the name ROHACELL®. Other nonporous materials that can be used for the core 14 include wood and other cellulosic material, a particularly notable example of which is balsa wood. These core materials are also well known in the art, and therefore will not be discussed in any detail. The thickness of the core 14 depends on the particular application of the composite structure being produced. For example, in the case of fan cowls a typical thickness is about twelve to about twenty-five millimeters, though much lesser and greater thicknesses are foreseeable.

Prior to impregnation with resin, the fabric stacks 16 and their individual fabric layers may be referred to as “dry” fabrics. Dry fabrics can be formed of a variety of materials, nonlimiting examples of which include fabrics formed of graphite, glass, polymer (e.g., an aramid such as Kevla®), and ceramic (e.g., Nextel®) fibers. As with the core 14, suitable individual thicknesses of the fabric layers and combined thicknesses of the layers to form the fabric stacks 16 will depend on the particular application of the composite structure being produced. As an example, in the case of a fan cowl a typical individual thickness for each fabric layer is about 0.2 to about 0.4 millimeters, and a typical thickness for a fabric stack 16 is about 1.3 to about 2.5 millimeters, though much lesser and greater thicknesses are also foreseeable.

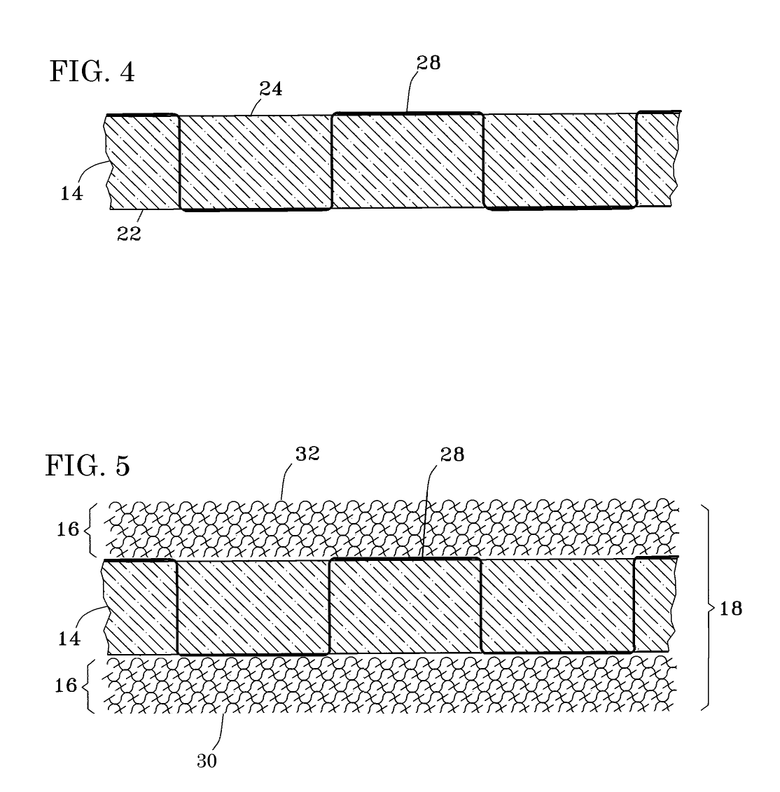

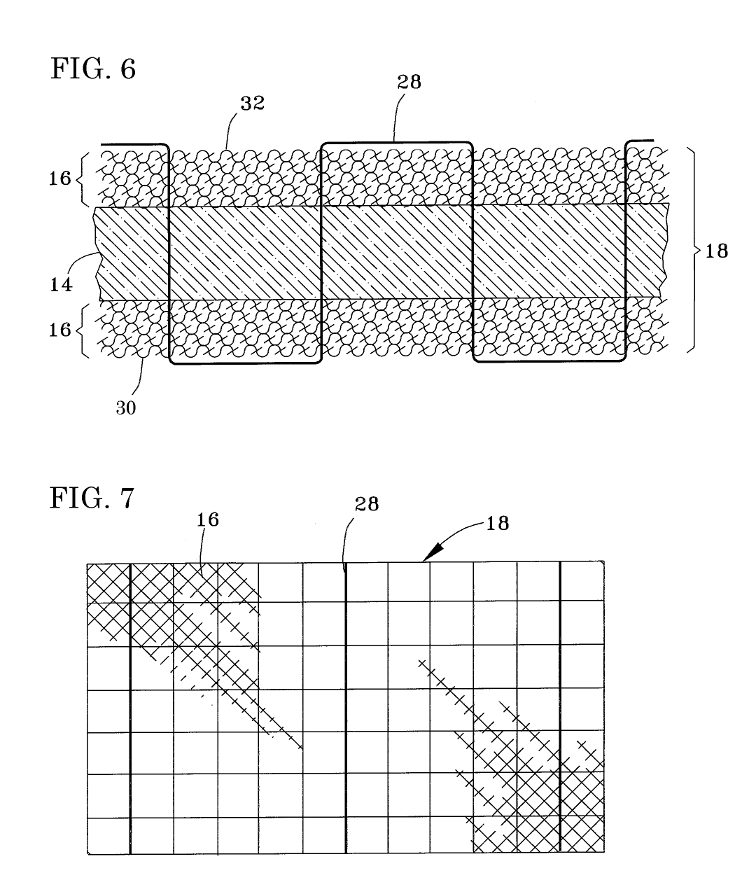

According to a particular aspect of the invention, cores used to fabricate the fan cowl 12 of FIG. 1 are preferably closed-cell structural foam materials, including those noted in reference to FIG. 3. However, as represented in FIGS. 4 through 8, the core 14 is reinforced to promote its shear and tension load-carrying capability while retaining certain advantages of structural foam materials, including lower-cost materials and processes such as RTM/VaRTM processes. In FIGS. 4 through 8, a roving 28 is stitched in a pattern through the entire thickness of the core 14, and as represented in FIGS. 6 through 8 the roving 28 may additionally be stitched through the entire thicknesses of fabric stacks 16 applied to opposite outer surfaces 22 and 24 of the core 14. In FIGS. 4 and 5, the roving 28 traverses the outer surfaces 22 and 24 of the core 14 (FIG. 4), whereas in FIGS. 6 through 8 the roving 28 traverses outer surfaces 30 and 32 defined by the fabric stacks 16.

In FIG. 4, the structural foam core 14 is shown without the fabric stacks 16 of FIG. 3. In this embodiment, the structural strength of the core 14 is enhanced by directly reinforcing its closed-cell foam structure with roving 28 stitched in a pattern through the thickness of the core 14, such that the roving 28 traverses portions of the outer surfaces 22 and 24 of the core 14. By itself, the core 14 of FIG. 4 defines a preliminary structure for the stitching operation. FIG. 5 represents the roving-reinforced core 14 of FIG. 4 between a pair of dry, unimpregnated fabric stacks 16, such that fabric stacks 16 overlay the roving 28 exposed at the surfaces 22 and 24 of the core 14. Together, the core 14 and fabric stacks 16 will be referred to as a laminate structure 18 whose outer surfaces 30 and 32 are defined by the stacks 16. As depicted in FIG. 5, the fabric stacks 16 are not yet impregnated with resin, which as will be discussed below can be subsequently performed to bond the fabric stacks 16 to the core 14 and yield a resin-impregnated composite structure.

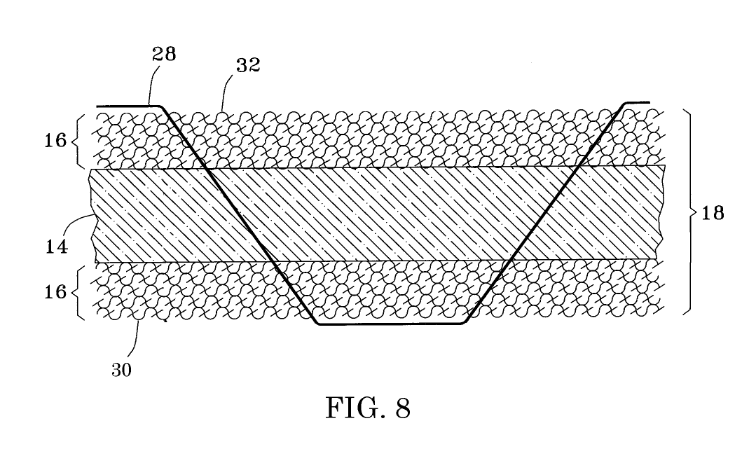

FIGS. 6 through 8 represent alternative embodiments, in which the core 14 and dry fabric stacks 16 are stitched together with the roving 28, so that the roving 28 structurally reinforces the entire laminate structure 18 formed by the core 14 and its fabric stacks 16. The embodiment of FIGS. 6 and 8 differ by the roving 28 passing through the core 14 of FIG. 6 at an angle normal to the core surfaces 22 and 24 and the outer surfaces 30 and 32 of the laminate structure 18 (defined by the stacks 16), whereas in FIG. 8 the roving 28 passes through the core 14 at an oblique angle (about forty-five degrees) to the core and outer surfaces 22, 24, 30 and 32. Each of these embodiments is capable of providing a more damage-tolerant structure as a result of the foam core 14 and fabric stacks 16 being stitched together. As with the embodiment of FIGS. 4 and 5, the fabric stacks 16 in FIGS. 6 and 7 are preferably in the dry condition, such that a subsequent resin-impregnation process is performed to impregnate the fabric stacks 16 and bond the stacks 16 to the core 14. Prior to the stitching operation, the core 14 and fabric stacks 16 of FIGS. 5 and 6 may be termed a preliminary structure whose outer surfaces 30 and 32 (defined by the stacks 16) are traversed by the roving 28 as a result of the stitching operation.

The roving 28 is generally a cord or rope of substantially parallel continuous fibers, and may be formed of graphite, glass, polymer (e.g., an aramid such as Kevlar®), or other material having similar properties in terms of temperature resistance, strength, and chemical compatibility with the materials of the core 14 and fabric stacks 16. A single roving 28 may be used to reinforce the core 14 or laminate structure 18, or multiple separate rovings 28 may be used. The roving 28 may comprise any number of continuous fibers, preferably at least 3000 filaments and as many as about 12,000 filaments in the case of a graphite roving 28. Suitable filament diameters can vary widely, depending on the particular application and the filament material. Suitable diameters for the roving 28 will depend on the material, diameter, and number of filaments in the roving 28, as well as the application and materials chosen for the filaments, core 14 and fabric stacks 16.

The roving 28 may be dry or pre-impregnated with a resin, including resins suitable for impregnating the fabric stacks 16. In the embodiments of FIGS. 4 through 8, the roving 28 can be stitched in a dry condition and then impregnated with resin and cured, or stitched in a resin-impregnated condition and cured. In the embodiment of FIGS. 4 and 5, curing of the resin of the roving 28 can be performed before or simultaneously with the curing of the resin-impregnated fabric stacks 16 subsequently laminated to the surfaces 22 and 24 of the core 14. In the embodiments of FIGS. 6 through 8, curing of the resin used to impregnate the roving 28 preferably occurs simultaneously with the resin used to impregnate the fabric stacks 16. Resin impregnation of the fabric stacks 16 and roving 28 can be performed by a vacuum-assisted resin transfer molding (VaRTM) process or a resin transfer molding (RTM) process. Notably, because of the closed-cell construction of the core 14, resin infusion can be achieved in a single-step process to wet out the fabric stacks 16 without unnecessarily increasing the weight of the final composite structure, as would be the case if the core 14 had an open-cell structure. Other resin-impregnation and infusion processes are also possible and within the scope of the invention. Alternatively, the roving-reinforced foam core 14 can be used with pre-impregnated fabric stacks 16 that are cured in an autoclave at high pressure.

The roving 28 is shown in FIG. 7 as defining a checkerboard pattern, though other patterns are also within the scope of the invention. The pattern for the roving 28 can be developed by creating small holes through the core 14 and optionally the fabric stacks 16 (if present). The pattern can be varied to provide desired tension or shear strength by changing the stitching angle through the thickness of the core 14 from the perpendicular orientation to the core surfaces 22 and 24 (FIG. 4) and fiber stack surfaces 30 and 32 (FIG. 6) to an oblique angle to these surfaces 22, 24, 30 and 32. The density of the pattern (hole spacing) can also be adjusted to influence the reinforcement effect of the roving 28. Center-to-center spacing between through-holes 34 of about twenty-five millimeters have yielded suitable results, with center-to-center hole spacings of as little as about ten to a large as about fifty millimeters believed to be a preferred range. While uniform hole spacings are represented in FIGS. 4 through 8, it is foreseeable that a nonuniform hole spacing could be employed, for example, with greater hole densities (and therefore greater roving densities) being utilized to modify the rigidity or strength of the core 14 and/or laminate structure 18.

The through-holes 34 can be formed using a variety of techniques, including piercing, mechanical or laser drilling, etc. Particularly suitable hole-forming processes for a given application will depend on the particular material, size, shape and thickness of the core 14. To promote impregnation of resin into portions of the roving 28 within the through-holes 34, it may be desirable or necessary to form the through-holes 34 in an oversize condition relative to the diameter of the roving 28. For example, the through-holes 34 may be formed to have diameters of about 0.7 mm greater, and more preferably about 1.0 to about 1.3 mm greater than the diameter of the roving 28. Particularly suitable diameters and spacings for the through-holes 34 will depend on the particular resin used to infiltrate the roving 28, including its viscosity and other flow characteristics. Following stitching and resin impregnation, the through-holes 34 will preferably be entirely closed by the combination of the roving 28 and the resin.

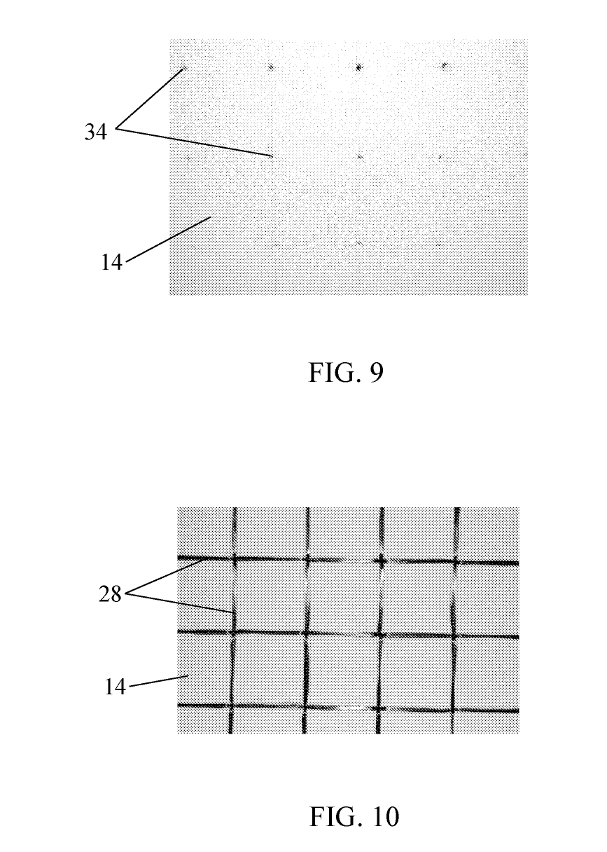

FIG. 9 is a scanned image of a closed-cell structural foam core 14 after through-holes 34 were formed in the core 14 and before being stitched with roving. FIG. 10 is a scanned image showing the core 14 of FIG. 9 after reinforcement with a graphite roving 28, corresponding to the embodiment of FIG. 4.

A wide variety of polymeric materials can be chosen as the resin used to infiltrate the roving 28 and the fabric stacks 16. The principle role of the resin is to infiltrate the roving 28 and fabric stacks 16 and form a matrix material for their respective fibrous materials, and as such the resin contributes to the structural strength and other physical properties of the roving 28 and fabric stacks 16, as well as the laminate structure 18 as a whole. Therefore, the resin should be compositionally compatible with the roving 28 and fabric stacks 16. Additionally, because the resin will contact the surfaces 22 and 24 of the core 14 and the walls of the through-holes 34 in the core 14, the resin must also be compositionally compatible with the material that forms the core 14. The resin must also be capable of curing at temperatures and under conditions that will not thermally degrade or otherwise be adverse to the materials of the core 14, fabric stacks 16, and roving 28. On this basis, particularly suitable resins materials are believed to include epoxies, with curing temperatures typically below 200° C., for example, about 180° C.

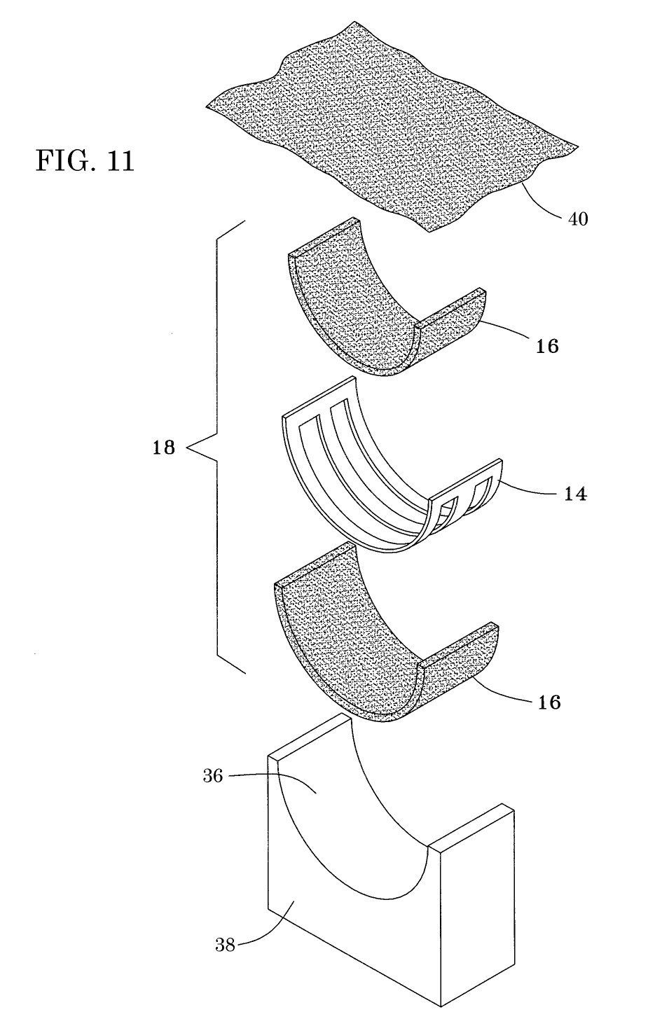

FIG. 11 schematically represents an arrangement of the core 14 and two fabric stacks 16 (minus the roving 28) on a mold cavity surface 36 of a mold 38 suitable for producing one of the cowls 12 of FIG. 1. When placed on the mold 38, the non-impregnated (dry) stacked laminate structure 18 formed by the core 14 and fabric stacks 16 conforms to the surface 36 of the mold 38. Other possible structural components of the molding system will depend on the technique used to resin-infiltrate the fabric stacks 16 and cure the resulting resin-impregnated stacked structure. For example, if a vacuum-assisted resin transfer molding (VARTM) method is used, the laminate structure 18 is covered by a bag 40 to enable a vacuum to be drawn between the mold cavity surface 36 and the bag 40, such that the bag 40 is able to compress the laminate structure 18 and draw resin through the structure 18. A bag 40 can similarly be used in an autoclave process, by which pressure is applied to the upper surface of the bag 40, such that the bag 40 compresses the laminate structure 18 and promotes the flow of resin through the fabric stacks 16. Once the resin has thoroughly infiltrated the fabric stacks 16 and the roving 28, the resulting resin-impregnated stacked structure can be heated to a temperature and for a duration sufficient to cure the resin. The infiltration/impregnation and curing temperatures, pressure/vacuum levels, and other parameters of the infiltration and curing cycles will depend on the particular materials used, and can be determined by routine experimentation.

While the invention has been described in terms of specific embodiments, it is apparent that other forms could be adopted by one skilled in the art. For example, the physical configuration of the composite structures, both before and after resin infiltration, could differ from that shown, and materials and processes other than those noted could be used. Therefore, the scope of the invention is to be limited only by the following claims.

1. A process of producing a resin-impregnated laminate composite structure comprising a core between resin-impregnated fabric layers, the process comprising:
stitching a roving in a preliminary structure comprising the core so as to structurally reinforce the core, the core being a closed-cell material and the roving passing through through-holes in the core and traversing opposite outer surfaces of the preliminary structure;
wherein the roving and a resin close the through-holes in the core.

2. The process according to claim 1, wherein the roving is pre-impregnated with the resin prior to the stitching step.

3. The process according to claim 1, wherein the through-holes are closed and the roving is impregnated with the resin after the stitching step.

4. The process according to claim 1, wherein the preliminary structure further comprises at least two fabric layers on outer surfaces of the core such that the core is between the two fabric layers, the roving passes through at least one of the at least two fabric layers, and at least one of the outer surfaces of the preliminary structure traversed by the roving is defined by the at least one fabric layer.

5. The process according to claim 4, wherein the roving passes through each of the at least two fabric layers, and the outer surfaces of the preliminary structure traversed by the roving are defined by the at least two fabric layers.

6. The process according to claim 4, wherein the roving is pre-impregnated with the resin prior to the stitching step.

7. The process according to claim 6, further comprising impregnating the at least two fabric layers with the resin after the stitching step.

8. The process according to claim 4, wherein the roving and the at least two fabric layers are impregnated with the resin and the through-holes are closed after the stitching step.

9. The process according to claim 4, further comprising placing the preliminary structure on a mold such that a first of the at least two fabric layers is disposed between a surface of the mold and a first of the outer surfaces of the core, a second of the at least two fabric layers is disposed at a second of the outer surfaces of the core, and the preliminary structure conforms to the surface of the mold;
infusing the resin into the preliminary structure to impregnate the at least two fabric layers; and then
curing the resin to cause the at least two fabric layers to bond to the core and thereby form the resin-impregnated laminate composite structure.

10. The preliminary structure produced by the process of claim 4.

11. The process according to claim 1, wherein the outer surfaces of the preliminary structure traversed by the roving are defined by outer surfaces of the core.

12. The process according to claim 11, further comprising applying at least two fabric layers to the outer surfaces of the core after the stitching step so that the core is between the at least two fabric layers, wherein the roving does not pass through any of the at least two fabric layers, and the roving is covered by the at least two fabric layers.

13. The process according to claim 12, wherein the roving is pre-impregnated with the resin prior to the stitching step.

14. The process according to claim 12, further comprising:
impregnating the at least two fabric layers with the resin after the stitching and applying steps; and then
curing the resin to cause the at least two fabric layers to bond to the core and thereby form the resin-impregnated laminate composite structure.

15. The process according to claim 12, wherein the applying step comprises placing the preliminary structure on a mold such that a first of the at least two fabric layers is disposed between a surface of the mold and a first of the outer surfaces of the core, a second of the at least two fabric layers is disposed at a second of the outer surfaces of the core, and the preliminary structure conforms to the surface of the mold;
infusing the resin into the preliminary structure to impregnate the at least two fabric layers; and then
curing the resin to cause the at least two fabric layers to bond to the core and thereby form the resin-impregnated laminate composite structure.

16. The preliminary structure produced by the process of claim 11.

17. The preliminary structure produced by the process of claim 12.

18. The process according to claim 1, wherein the core is formed of a material chosen from the group consisting of polymeric and cellulosic materials.

19. The process according to claim 1, wherein the roving comprises graphite fibers.

20. The process according to claim 1, wherein the resin-impregnated laminate composite structure is a component of an aircraft nacelle.
